(19) United States
(12) Patent Application Publication
(10) Pub. No.: US 2010/0262114 A1
(43) Pub. Date: Oct. 14, 2010

(54) PARISON AND METHOD FOR THE PRODUCTION OF A RECEPTACLE USED FOR HOLDING LIQUIDS FOR MEDICAL APPLICATIONS

(75) Inventors: Torsten Brandenburger, Reichelsheim (DE); Gerhard Greier, Friedrichsdorf (DE); Ismael Rahimy, Friedberg (DE)

Correspondence Address: OCCHIUTI ROHLICEK & TSAO, LLP, 10 FAWCETT STREET, CAMBRIDGE, MA, 02138, US

(73) Assignee: Fresenius Kabi Deutschland Gmbh, Bad Homburg v.d.H. (DE)

(21) Appl. No.: 12/740,407

(22) PCT Filed: Nov. 19, 2008
(86) PCT No.: PCT/EP2008/009753

§ 371 Date: Apr. 29, 2010

(30) Foreign Application Priority Data
Nov. 22, 2007 (DE) 10 2007 056 486.6

(51) Int. Cl. A61J 1/16; B29C 49/02

(52) U.S. Cl. 604/403; 428/34.1; 264/513

(57) ABSTRACT

The invention relates to a parison for producing a receptacle used for holding liquids for medical applications, especially for holding infusion solutions or enteral nutrient solutions. The invention further relates to a method for producing such receptacles as well as such a receptacle. The parison according to the invention comprises a neck part (1) with an opening (1A), a wall part (2), and a bottom part (3) and is characterized in that one end of a section (5B) of an annular suspension device for suspending the receptacle is molded onto the underside of the bottom part (3). The free end of said section (5B) can be connected to the underside of the bottom part (3) such that the section (5B) is deformed and the annular suspension device is formed. First, the parison is produced, whereupon the receptacle is formed from the parison by means of a drawing and blow molding process. Preferably, the parison is produced in an injection molding process. It is crucial that the section of the annular suspension device is not yet connected to the bottom part to form the annular suspension device when the parison is injection-molded, resulting in a simplified injection molding process for producing the parison.

The invention relates to a parison for the production of a receptacle used for holding liquids for medical applications, in particular for holding infusion solutions, transfusion solutions or enteral nutrient solutions. Moreover, the invention relates to a method for the production of a receptacle for holding liquids for medical applications, in particular infusion solutions, transfusion solutions or enteral nutrient solutions. Furthermore, the invention relates to a receptacle for holding liquids for medical applications.

A large number of receptacles of varying design for holding liquids are known. Receptacles for holding liquids for medical treatments must meet particular requirements, especially with regard to sterility.

Receptacles for medical liquids, for example bottles made of extruded PE or PP, are known, which are brought into the desired shape in one work cycle in a sterile and pyrogen-free manner by biaxial drawing and blow-moulding of a parison, which is also referred to as a preform, are filled aseptically after cooling with a sterile filling substance and then hermetically sealed. These receptacles, in particular bottles, produced according to the blow-fill-seal method, are also referred to as BFS receptacles.

The known receptacles for infusion solutions or enteral nutrient solutions are generally suspended on a stand. For this purpose, the receptacles comprise a suspension device. Numerous receptacles are known that comprise a suspension device which is a one-piece component of the receptacle. EP 070 641 A1 and U.S. Pat. No. 3,901,399, for example, describe bottles onto the bottom part of which suspension devices are moulded. The suspension devices are constituted as eyelets, so that the bottle can be suspended on a hook.

EP 0 483 671 B1 describes a method for the production of an infusion receptacle which comprises an annular suspension device at the bottom of the bottle. The bottle is produced by biaxial drawing and blowing from a parison (preform). The parison itself is produced together with the annular suspension device in the injection moulding process. The known production methods are characterised in that a further work step is not required for the fixing of a suspension device after the blow moulding.

It is an object of the invention to provide a parison with which a receptacle used for holding liquids for medical applications, in particular for holding infusion solutions or enteral nutrient solutions, can be produced with a suspension device in a straightforward manner. Moreover, it is an object of the invention to provide an easily performable method for producing a receptacle used to hold medical liquids which comprises a suspension device. A further object of the invention is to provide an easily producible receptacle used to hold medical liquids.

The invention achieves these objects by means of the features of claims 1, 10 and 13. Advantageous embodiments of the invention are the subject-matter of the sub-claims.

The parison according to the invention for the production of a receptacle for medical liquids, which comprises a neck part with an opening, a wall part and a bottom part, is characterised in that one end of a section of an annular suspension device for suspending the receptacle is moulded onto the underside of the bottom part, the free end of the section being able to be connected to the underside of the bottom part such that said section is preferably deformed and the annular suspension device is formed.

The annular suspension device can be shaped to be circular or oval. In principle, however, angular shapes are also possible, as long as the suspension device forms a closed annular shape.

The parison is first produced, the free end of the section of the suspension device not yet being connected to the underside of the bottom part. The receptacle is then formed by stretching and blow-moulding from the parison. The process steps required for this are known to the person skilled in the art.

The parison itself is preferably produced in the injection moulding process. The process steps required for this are also known to the person skilled in the art. It is crucial that the section of the suspension device is not yet connected to the bottom part during the injection moulding of the parison. The injection moulding process for the production of the parison is thus simplified. The result is a relatively high filling rate of the moulding tool in the region of the suspension device on account of a smaller injection diameter through two injection points, so that the cycle times are shortened. Furthermore, it results in a precise wall thickness distribution and rapid cooling and thus a better detachment from the moulding tool. Furthermore, the full volume of the bottle is utilised.

The connection of the section of the suspension device to the bottom part can take place after the injection moulding process, during the stretch-blowing or not until later on with the customer.

In a preferred embodiment of the parison, the section of the suspension device is constituted as a flexible strip. The mobility required in order to form the section into the annular suspension device can be achieved by selecting a material with sufficient flexibility and/or by suitable dimensioning of the cross-section of the section.

The section of the suspension device is preferably constituted as a flat strip with a rectangular cross-section. Sufficient flexibility thus results even with a less flexible material. In any event, the material should be flexible enough not to break during bending. Instead of a rectangular cross-section, however, a circular cross-section is also possible.

In another preferred embodiment, the free end of the section and the bottom part can be connected to one another with a keyed connection, preferably with a snap-in or catch connection, so that the connection can likewise not take place until with the customer. The free end of the section preferably comprises a shoulder, which can be inserted into an undercut recess of the bottom part.

In principle, however, other connection techniques are also possible. Thus, the free end of the section of the suspension device can for example also be welded or riveted to the bottom part.

The section of the suspension device is preferably preformed into an eyelet, so that it can easily be formed into the annular suspension device. In principle, however, it is also possible to constitute the section essentially straight or only slightly bent. Then, however, greater flexibility is required in order to be able to bend the section to form the annular suspension device.

A further particularly preferred embodiment makes provision such that the end of the section moulded onto the underside of the bottom part is constituted as a base piece moulded onto the underside of the bottom part, with which the free end of the section can be connected such that said section is deformed and the annular suspension device is formed. The base piece is preferably constituted as a flat body.

Various embodiments of the invention are explained in greater detail below by reference to the drawings.

In the figures:

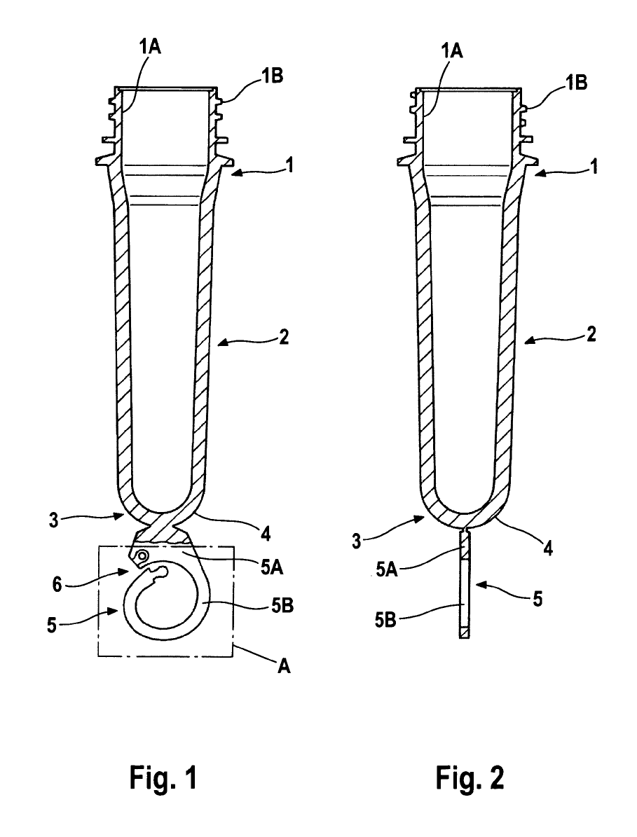

FIG. 1 shows an example of embodiment of the parison according to the invention in a cross-sectional representation,

FIG. 2 shows a cross-section through the parison of FIG. 1,

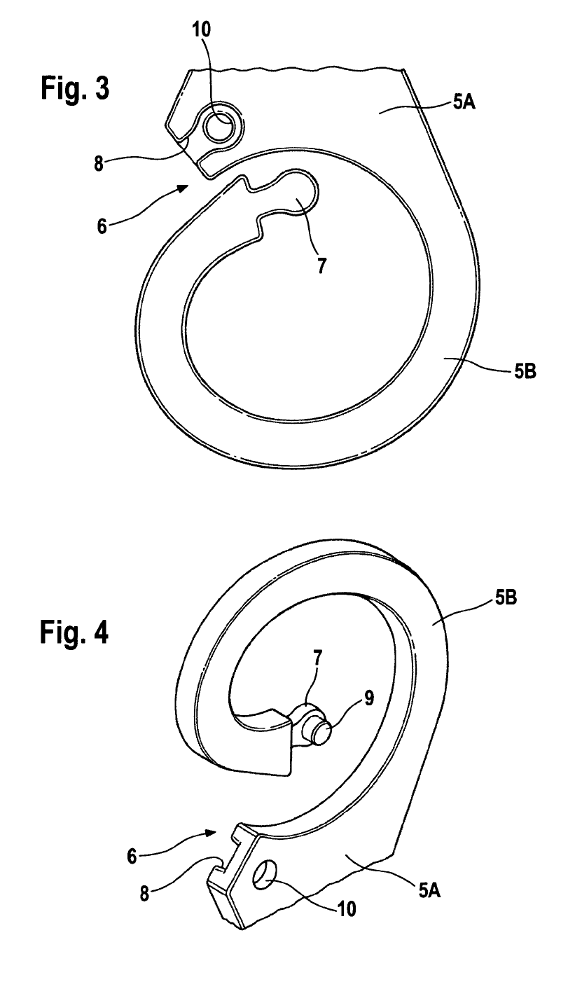

FIG. 3 shows detail A of FIG. 1 in a magnified representation and

FIG. 4 shows a perspective representation of detail A of FIG. 1.

FIGS. 1 and 2 show, in a cross-sectional representation, an example of embodiment of the parison according to the invention for the production of a receptacle used to hold a medical liquid, in particular an infusion solution or an enteral nutrient solution. The parison is produced in the injection moulding process, in particular in the injection moulding process with two or three components of plastic, in particular polypropylene PP, polyethylene PE, PET or a combination of PP, PE, PET, which has a sufficient stability. The parison comprises a neck part 1 with an opening 1A, which is provided with an external thread 1B. Neck part 1 is followed by a wall part 2, which transforms into a bottom part 3.

Bottom part 3 of the parison comprises a section 4 with a hemispherical cross-section, onto the underside of which a plastic part 5 is moulded, which later forms the suspension device.

Plastic part 5 forming the suspension device comprises a flat base body 5A, which is moulded onto the underside of hemispherical section 4 of bottom part 3 and is thus a one-piece component of the bottom part. One side of base body 5A is followed by a flat section 5B, which is curved inwards to form an eyelet, in such a way that the free end of the section extends close up to the other side of base body 5A. Flat section 5B has a rectangular cross-section.

By means of a catch or snap-in connection 6, the free end of section 5B can be connected to base body 5A thereby forming a suspension device with an essentially circular cross-section. The catch or snap-in connection comprises a projecting shoulder 7 at the free end of section 5B, which can be inserted in a matching manner into an undercut recess 8 in base body 5A. A keyed tongue-and-groove joint is thus created.

In order to secure the tongue in the groove, projecting shoulder 7 comprises, at the free end of section 5B, a head 9 with a circular cross-section, which can be pressed in a snap-in manner into a hole 10 at the bottom of recess 8 of base body 5A. A connection in the manner of a push-button is thus created.

A riveted joint can also be provided instead of a connection in the manner of a push-button. In the case of the riveted joint, hole 10 at the bottom of recess 8 serves as a drill-hole for receiving a rivet which, instead of the push-button, is moulded onto projecting shoulder 7. The rivet, which has a somewhat smaller diameter than the drill-hole, is pushed through the drill-hole, so that the rivet shaft projects out of the drill-hole. In order to join the two components, the projecting end of the rivet is deformed, by working in the width, into a so-called closing head, which securely connects the components. The working can take place either by exerting a sudden pressure (striking) or continuous pressure (cold pressing) or by heat effect, so that the materials are welded. The riveted joint has the advantage that a thread does not have to be introduced or similar connection techniques provided in either of the components, although the connection is friction-locked such that it cannot be detached without destruction.

FIGS. 3 and 4 show the suspension device in a magnified representation before the connection of section 5B of the suspension device to base body 5A. The pieces to be connected to one another lie close beside one another. After the connection of the section with the base body, the suspension device forms a circular eyelet.

The receptacle is moulded from the parison by biaxial stretching and blowing according to the known processes. The shape of the suspension device thereby remains unchanged. It is only after the injection moulding that the section is connected to the base body thereby forming the suspension device. The injection moulding is thus simplified. The welding process is preferably carried out during the stretching and blowing. In principle, however, it is also possible to connect the section and the base body to one another before the stretching and blowing, but after the injection moulding.

1. A parison for the production of a receptacle used to hold liquids for medical applications, in particular to hold infusion solutions or enteral nutrient solutions, wherein the parison comprises a neck part with an opening, a wall part and a bottom part,
characterised in that one end of a section of an annular suspension device for suspending the receptacle is moulded onto the underside of the bottom part, the free end of the section being able to be connected to the underside of the bottom part to the annular suspension device.

2. The parison according to claim 1, characterised in that the section of the suspension device is constituted as a flexible strip.

3. The parison according to claim 2, characterised in that the flexible strip is constituted as a flat strip with a rectangular cross-section.

4. The parison according to claim 1, characterised in that the free end of the section of the suspension device and the bottom part can be connected to one another with a keyed connection.

5. The parison according to claim 4, characterised in that the keyed connection is a snap-in or catch connection.

6. The parison according to claim 4, characterised in that the free end of the section of the suspension device comprises a shoulder and the bottom part comprises an undercut recess, the shoulder of the section being able to be inserted into the undercut recess of the bottom part.

7. The parison according to claim 4, characterised in that the keyed connection is a riveted joint.

8. The parison according to claim 1, characterised in that the section of the suspension device is preformed into an eyelet.

9. The parison according to claim 1, characterised in that the end of the section of the suspension device moulded onto the underside of the bottom part is constituted as a base piece moulded onto the underside of the bottom part, with which the free end of the section can be connected such that said section is deformed and the annular suspension device is formed.

10. The parison according to claim 9, characterised in that the base piece is constituted as a flat body.

11. Production of a receptacle used to hold medical liquids, in particular to hold infusion solutions or solutions for enteral nutrition, with the following process steps:
preparation of a parison in accordance with claim 1, stretching and blow-moulding of the parison to form a receptacle,
connection of the free end of the section of the suspension device to the underside of the bottom part to form the annular suspension device.

12. The method according to claim 11, characterised in that the free end of the section of the suspension device is connected in a keyed manner to the underside of the bottom part.

13. The method according to claim 11, characterised in that the parison is produced by the injection moulding process.

14. A receptacle used to hold medical liquids, in particular to hold infusion solutions or solutions for enteral nutrition, characterised in that the receptacle is produced according to the method according to claim 11.
